(19) United States
(12) Patent Application Publication
(10) Pub. No.: US 2002/0004458 A1
(43) Pub. Date: Jan. 10, 2002

(54) Methods for inducing production of isoflavone levels in plants using nuclear receptor ligands

(76) Inventors: Terrence L. Graham, Hilliard, OH (US); Lian-Mei Y. Graham, Hilliard, OH (US); Serena Landini, Columbus, OH (US)

Correspondence Address: CALFEE HALTER & GRISWOLD, LLP, 800 SUPERIOR AVENUE, SUITE 1400, CLEVELAND, OH, 44114, US

(21) Appl. No.: 09/781,695

(22) Filed: Feb. 12, 2001

Related U.S. Application Data
(60) Provisional application No. 60/181,707, filed on Feb. 11, 2000.

(51) Int. Cl. A01N 37/00; A01N 35/00; A01N 31/00

(52) U.S. Cl. 504/320; 504/348; 504/353

(57) ABSTRACT

Methods for increasing the levels of isoflavones in plants are provided. The method comprise applying a biologically effective amount of composition comprising a select nuclear receptor ligand to the plant. Compositions for inducing the production of isoflavones in plants are also provided. Such compositions comprise one or preferably, a combination of the select nuclear receptor ligands. The compositions also comprise a compound that enhances the capacity of the plant to release daidzein and/or utilize it for the production of glyceollin. The action of such a compound is complementary to that of the nuclear receptor ligand.

This application claims priority from U.S. Provisional application Serial No. 60/181,707, filed Feb. 11, 2000.

### FIELD OF THE INVENTION

The present invention relates to the field of inducing disease resistance in plants. More specifically, this invention relates to the induction of natural plant disease resistance by inducing the production of isoflavones in a plant.

### BACKGROUND OF THE INVENTION

A serious problem affecting modem agriculture is the prevalence of plant diseases caused by infectious agents. Soybean losses to the pathogen Phytophthora sojae alone cause an estimated annual loss of $250 million in the United States. Another soybean pathogen, Sclerotina sclerotiorum (white mold), accounts for an estimated average annual loss of roughly 26 million dollars. Losses resulting from other crop diseases, including those caused by various other fungi, bacteria, viruses and nematodes cause substantial economic losses world wide.

In recent years, a number of strategies for combating plant disease have been developed. The most common strategy involves application of chemical or biological agents to the surface of plants. The object is to block entry of potential pathogens into the plant. Although such agents can be effective, their effectiveness in adverse weather conditions can be significantly diminished. In addition, their use in some cases (i.e., chemical pesticides) is a potential cause of environmental and human health problems.

A second strategy involves genetically-engineering plants to produce substances toxic to plant pathogens. Although such methods are efficient and safe, their acceptance by the public, both in the U.S. and abroad, has been a serious drawback to a more prevalent use.

A third strategy, which has been the subject of many recent studies, focuses on augmenting the intrinsic defense mechanisms of plants. Such mechanisms are often induced by infection of the plant by a pathogen or by wounding. Localized infection by a pathogen results in the induction of physical changes, including cell wall lignification and papilla formation at the site of infection (reviewed in Kessmann, H., Staub, T., Hofinann, C., Maetzke, T., Herzog, J., Ward, E., Uknes, S., and J. Ryals. 1994. Induction of systemic acquired resistance in plants by chemicals. Annual Review of Phytopathology 32: 439-459; Schneider, M., Schweizer, P., Meuwly, P., and J. P. Metraux. 1996. Systemic acquired resistance in plants. International Journal of Cytology 168: 303-340; Sticher, L., Mauch-Mani, B., and J. P. Metraux. 1997. Systemic acquired resistance. Annual Review of Plant Pathology 35: 235-270). In addition, pathogen infection can result in induction of signal transduction pathways in the plant. Induction of such pathways leads to systemic resistance to pathogens, extending to uninfected parts of the plant. Induction of such pathways causes resistance against a broad spectrum of different plant pathogens, not just resistance against the pathogen causing the infection. While the conditioned state associated with systemic resistance is often transient, under some circumstances it can be sustained. Other terms used for conditioning include “priming,” “activation,” “potentiation,” and “competency.”

At least two different signal transduction pathways. appear to be involved in systemic resistance, although both similarly condition the plant to resist further pathogenic attacks. Systemic acquired resistance (SAR) is characterized by an accumulation of salicylic acid (SA) in plant tissues, and an increase in a class of proteins termed pathogenesis-related (PR) proteins (reviewed in Kessmann, H., Staub, T., Hofinann, C., Maetzke, T., Herzog, J., Ward, E., Uknes, S., and J. Ryals. 1994. Induction of systemic acquired resistance in plants by chemicals. Annual Review of Phytopathology 32: 439-459; Hunt, M. D., and J. A. Ryals. 1996. Systemic acquired resistance signal. transduction. Critical Review in Plant Science 15: 583-606; Ryals, J., Neuenschwander, U., Willits, M., Molina, A., Steiner, H. Y., and M. Hunt. 1996. Systemic acquired resistance. Plant Cell 8: 1809-1819; Schneider, M., Schweizer, P., Meuwly, P., and J.P. Metraux. 1996. Systemic acquired resistance in plants. International Journal of Cytology 168: 303-340; Yang, Y. O., Shah, J., and D. F. Klessig. 1997. Signal perception and transduction in defence responses. Genes and Development 11: 1621-1639).

A second signal transduction pathway, termed induced systemic resistance (ISR), operates independently of the SAR pathway. An illustrative example is a study that demonstrated the plant growth-promoting rhizobacteria (PGPR) induced a systemic resistance like phenomena without accumulation of SA or PR gene expression (Pieterse, C. M. J., Van Wees, S. C. M., Hoffland, E., Van Pelt, J. A., and L.C. Van Loon. 1996. Systemic resistance in Arabidopsis induced by biocontrol bacteria is independent of salicylic acid accumulation and pathogenesis-related gene expression. Plant Cell 8: 1225-1237).

Not all plants possess both of these signal transduction pathways. For example, soybeans are believed to lack the elements required for an SAR response: While treatment of soybean cotyledon tissues with either methyl jasmonate or 1 -aminocyclopropanecarboxylic acid gives rise to protection of cells distal from the point of application (Park, D.-S. 1998. Proximal cell competency and distal cell potentiation in soybean resistance. Ph.D. Thesis. The Ohio State University), SA does not induce any detectable changes in soybean defense pathways.

In addition to this ISR pathway, it has been suggested that soybeans may have a response that may “substitute” for the SA response seen in most plants. This substitute response is characterized by a high accumulation of conjugates of the isoflavone genistein. Genistein is a normally present in the apoplast of soybean seedling, tissues as a malonyl glucosyl conjugate (MGC) and is likely released from the conjugate by a highly isoflavone-specific enzyme, apoplastic (3-glucosidase (Hsieh, M.-C. 1997. Purification and characterization of an isoflavone specific (3-glucosidase from soybean. Ph.D. Thesis, The Ohio State University). Genistein is then thought to act in a manner somewhat similar to SA in activating the defense potential of soybean cells (T. L. Graham and M. Y. Graham 2000. Defense Potentiation and Elicitation Competency: Redox Conditioning Effects of Salicylic Acid and Genistein, pp. 181-219, Plant-Microbe Interactions, G. Stacey and N. Keen, eds).

Isoflavones, such as genistein, are phytoestrogens that are naturally produced in plants including those belonging to the family Leguminosae, particularly in plants belonging to the subfamily, the Papilionoidease, which includes soybeans. Recent studies have shown that plants which do not belong to the family Leguminosae can be genetically engineered to produce isoflavones. For example, Arabidopsis thaliana has been transformed with a single enzyme which allows it to produce genistein (Yu, Oliver; Jung, Woosuk; Shi, June; Croes, Robert A.; Fader, Gary M.; McGonigle, Brian; Odell, Joan T. 2000. Production of the isoflavones genistein and daidzein in non-legume dicot and monocot tissues. Plant Physiology 124:781-793).

In the plant, isoflavones are attached to a sugar molecule, usually glucose. Such conjugates are not biologically active. The free isoflavone form, which is known as an “aglycone” is released upon wounding or infection by a pathogen, hence the induction of the defense system. Once released, the aglycones can play multiple roles in the establishment of the capacity of the cell to mount an effective defense response. First, the isoflavone daidzein is a precursor of the plant antibiotic “phytoalexin”, glyceollin. Secondly, the closely related isoflavone genistein activates the soybean's capacity (competency) to recognize “elicitors” from the pathogen to trigger the formation of glyceollin from daidzein. (See FIG. 1) Finally, genistein itself has some antibiotic activity. Thus, the simple release of these two aglycones enhances three critical and complementary aspects of plant defense. Application of methyl jasmonate greatly potentiates this response (Graham, T. L., and M. Y. Graham. 1996. Signaling in soybean phenylpropanoid response: dissection of primary, secondary and conditioning effects of light, wounding and elicitor treatments. Plant Physiology 110: 1123-1133). The accumulation of isoflavone conjugates thus “loads” the capacity of the soybean to respond to a pathogen. The formation of glyceollin from released daidzein “taps” into this pool of isoflavones.

In addition to their anti-pathogenic effects on plants, the presence of isoflavones in plants may confer medicinal effects on those who eat such plants. Phytoestrogens, one type being isoflavones, are important natural supplements to the human body's own estrogens. For example, the dietary intake of phytoestrogens is thought to account, at least in part, for the lower incidence of estrogen deficiencies and post-menopausal problems in Asian women, who ingest a steady and high concentration of soybean products. Genistein is the most potent of all the phytoestrogens and is the major phytoestrogenic activity in soybean food products, such as tofu and miso, which are a major dietary component for Asian women. Because of its estrogenic activity and its anti-oxidative activity, genistein is also under investigation for its anti-cancer effects, particularly against hormone-dependent breast cancer.

Unfortunately, for both anti-pathogenic effects in plants as well as its beneficial medical effect in humans, the levels of the isoflavones in soybean seeds and plants are often too low to produce the optimum results. In the case of plant resistance to pathogens, some plant tissues (for instance, mature leaves) have very low levels of isoflavones. In addition, the isoflavone content of such tissues are decreased under certain environmental conditions (such as low light in cloudy weather). In the case of estrogenic and anti-cancer activity in humans, the genistein content of soybean seeds is often variable and low. It is soybean seeds that are used to make food products, such as tofui and miso.

Currently, there are no known methods for increasing the levels of isoflavones in plants. Accordingly, it is desirable to have methods that can be used to increase the isoflavone levels in plants and to thereby increase their resistance to attack by phytopathogens as well as to improve the estrogenic effect of soybean products ingested by humans.

### SUMMARY OF THE INVENTION

The present invention provides methods for increasing the levels of isoflavones in plants. The method comprises applying a formulation comprising a phytologically acceptable carrier and an effective amount of a compound referred to hereinafter as a “loader” to the plant. The loader is a nuclear receptor ligand selected from the group consisting of

(1) a steroid having structure I or structure II as below,

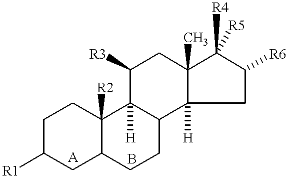

Wherein rings A, B have the same or different degrees of saturation,

wherein

R1=OH or O,

R2=H or CH₃,

R3=O, OH, or H,

R4=O, OH, H, CO₂H, C(O)CH₂OH or C(O)CH₃

R5=OH or H, and

R6=CH₃, OH or H;

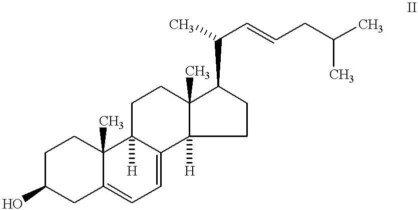

(2) a phenolic compound, wherein the phenolic compound is a phenolic estrogen or a diphenyl having structure III as below,

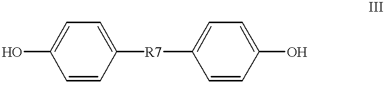

Wherein R7=a direct connection (single bond) or a branched or unbranched alkene or alkane;

(3) a long chain fatty acid having structure IV below,

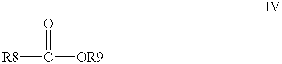

Wherein R8 is a saturated or unsaturated aliphatic chain comprising from 5 to 25 carbon atoms and R9 is a hydrogen or an aliphatic chain with 1-5 carbons;

(4) a peroxisome proliferator having structure V below,

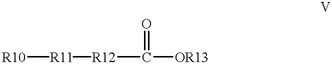

Wherein R10 is an aromatic ring or rings,

R11 is an O or S,

R12 is a branched or linear aliphatic chain comprising 1-8 carbons,

R13 is an aliphatic chain comprising from 1 to 5 carbon atoms; and

(5) the fungal steroid zearalenone, having structure VI below,

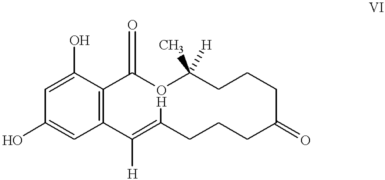

Advantageously, the present method enhances the glyceollin elicitation competency of the treated plant. In addition, the present methods provide an environmentally safe, effective and convenient formulation and method for triggering ISR and increasing the levels of plant isoflavones.

The present invention also relates to compositions for inducing the production of isoflavones in plants. Such composition comprises one or, preferably, a combination of the above-described loaders. Optionally the composition may further comprise a compound that enhances the capacity of the plant to release daidzein and/or utilize it for the production of glyceollin. The action of such a compound, referred to hereinafter as a “tapper”, is complementary to an isoflavone “loader”.

### BRIEF DESCRIPTION OF THE FIGURES

FIG. 1 depicts a working model for the establishment of elicitation competency in soybeans via release of isoflavone conjugates. Recently it has been proposed that genistein also acts as an internal plant signal to trigger the initiation of hypersensitive cell death (a defense response in plants parallel in some ways to apoptosis in animals) and to establish the competency of soybean cells to accumulate antibiotic phytoalexins in response to inducing signals called elicitors from the cell wall of the pathogen (in T. L. Graham and M. Y. Graham. 1999. Role of hypersensitive cell death in conditioning elicitation competency and defense potentiation, Physiol. Molec. Plant Pathol. 55:13-20.). Thus genistein serves as a plant hormone-like signal which programs several aspects of cellular response.

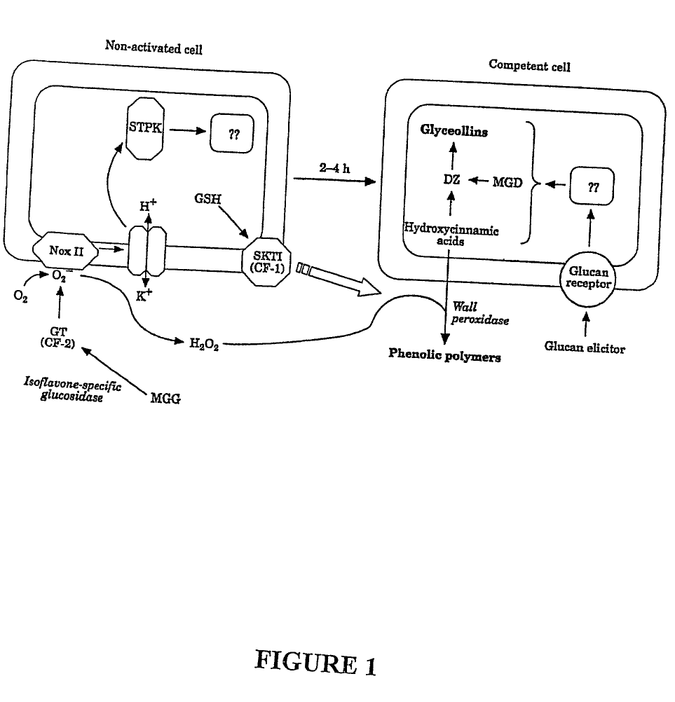

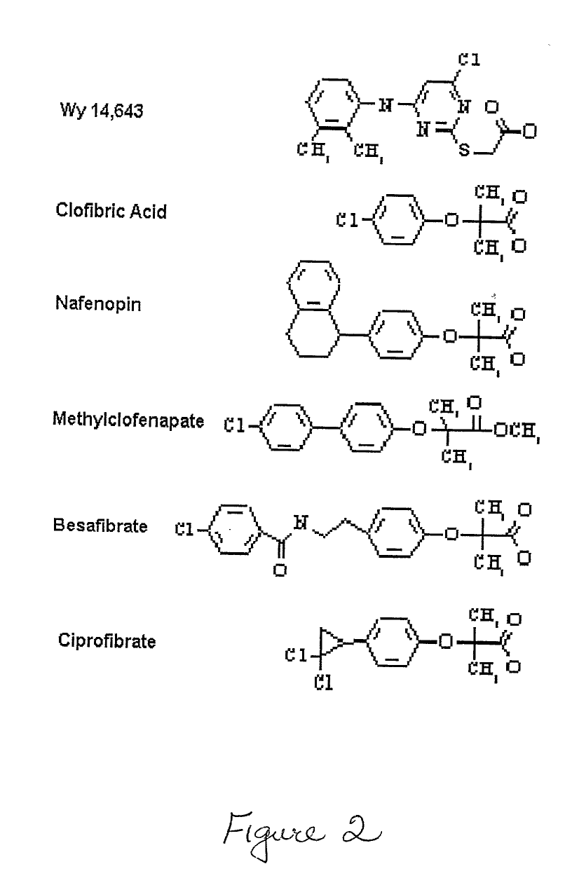

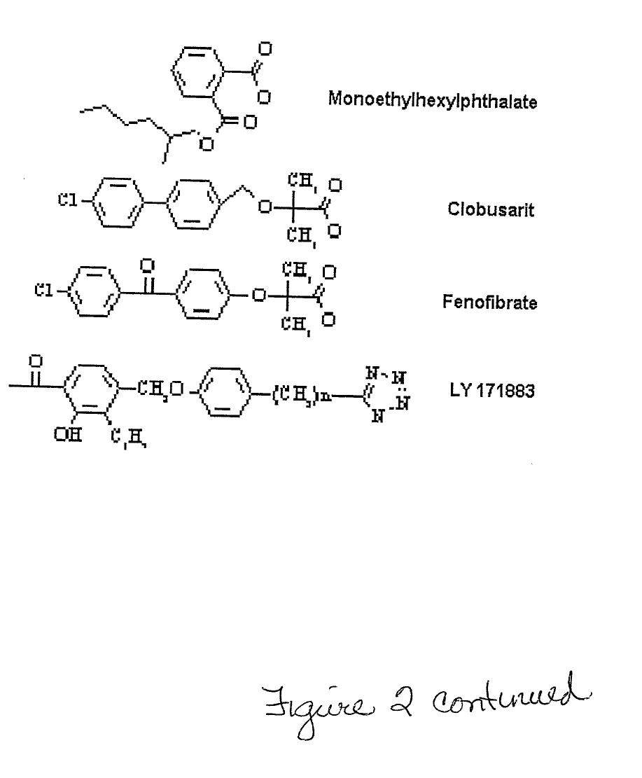

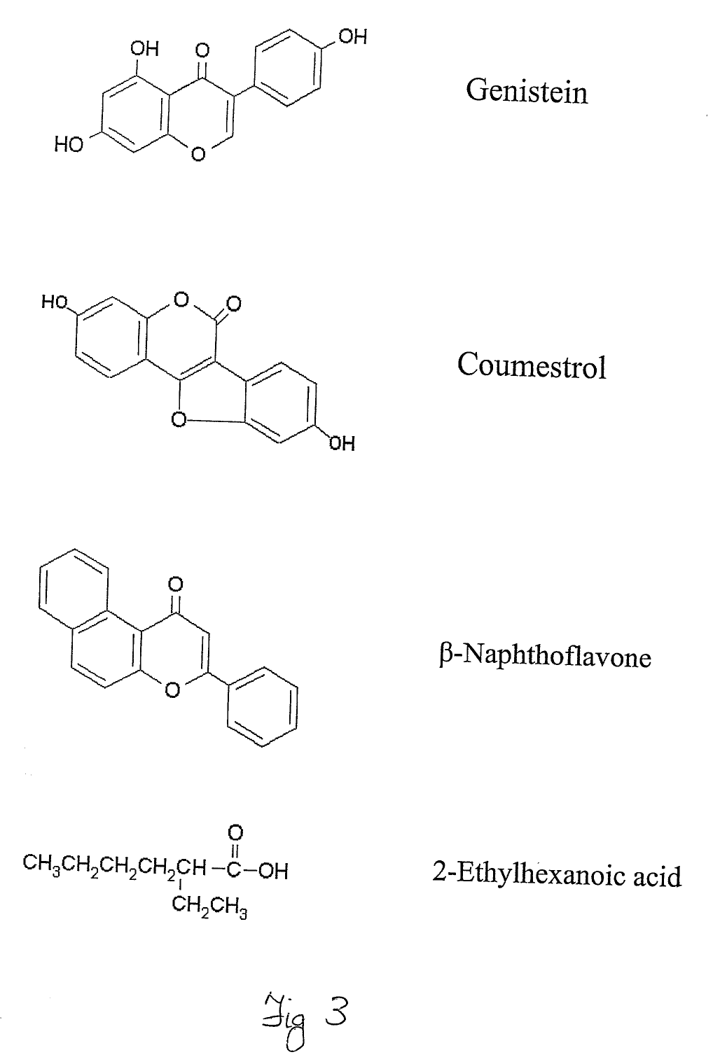

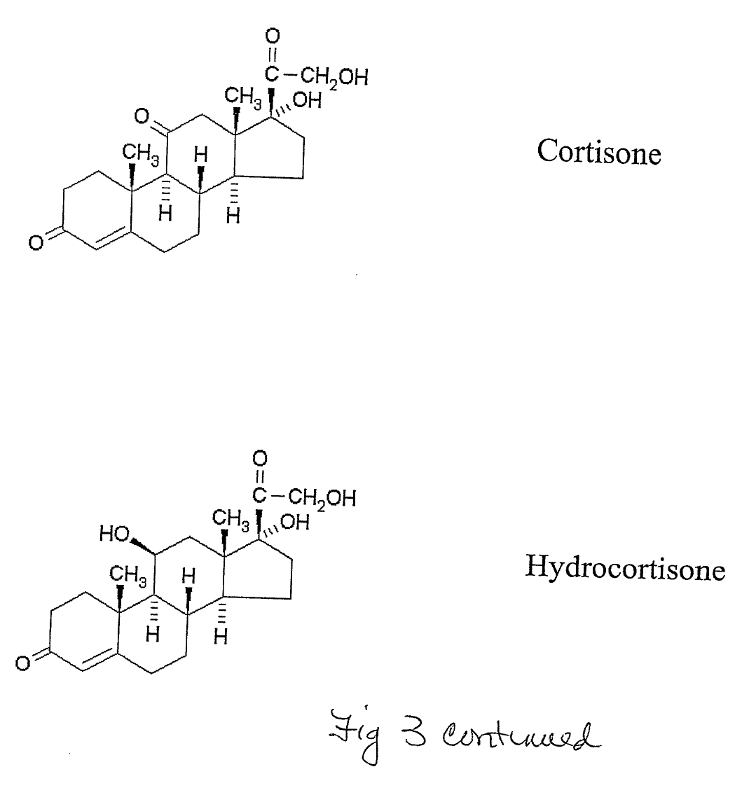

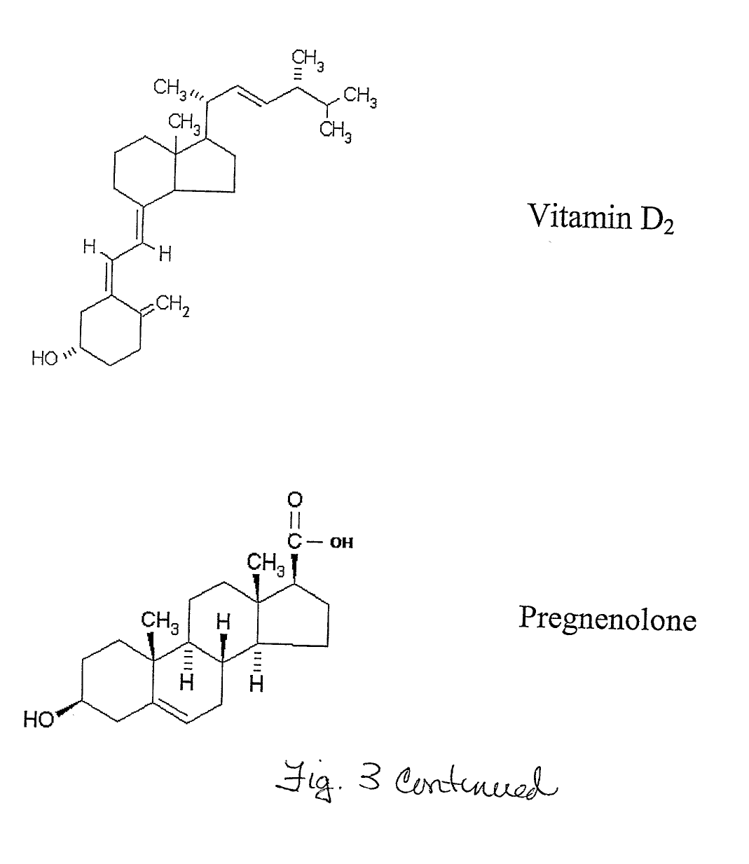

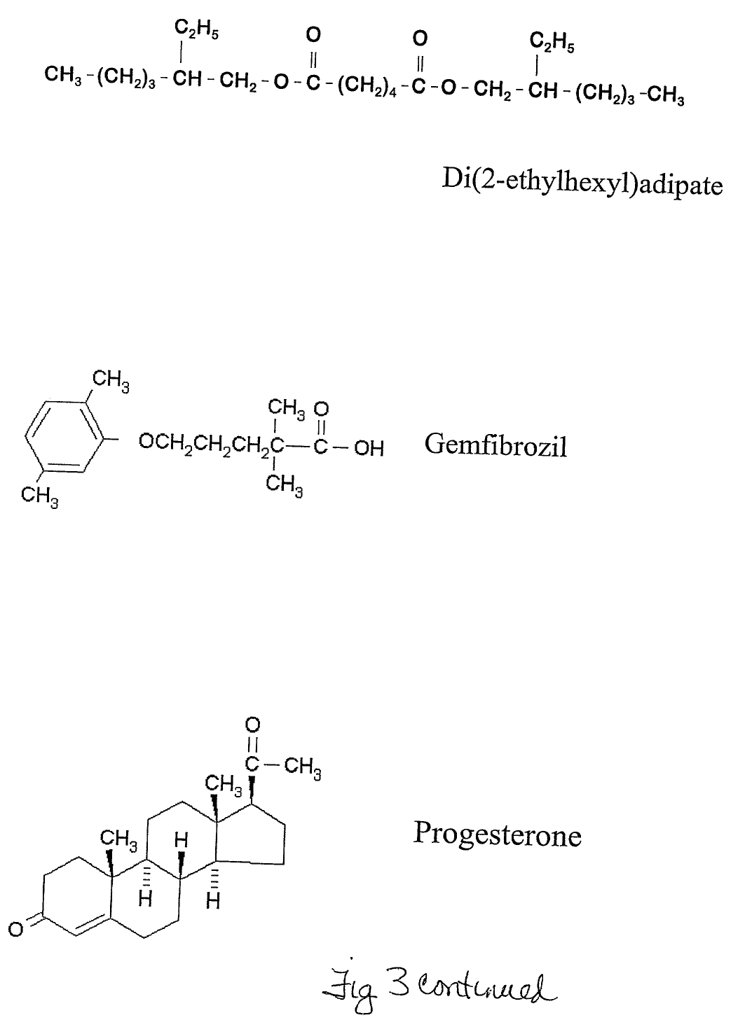

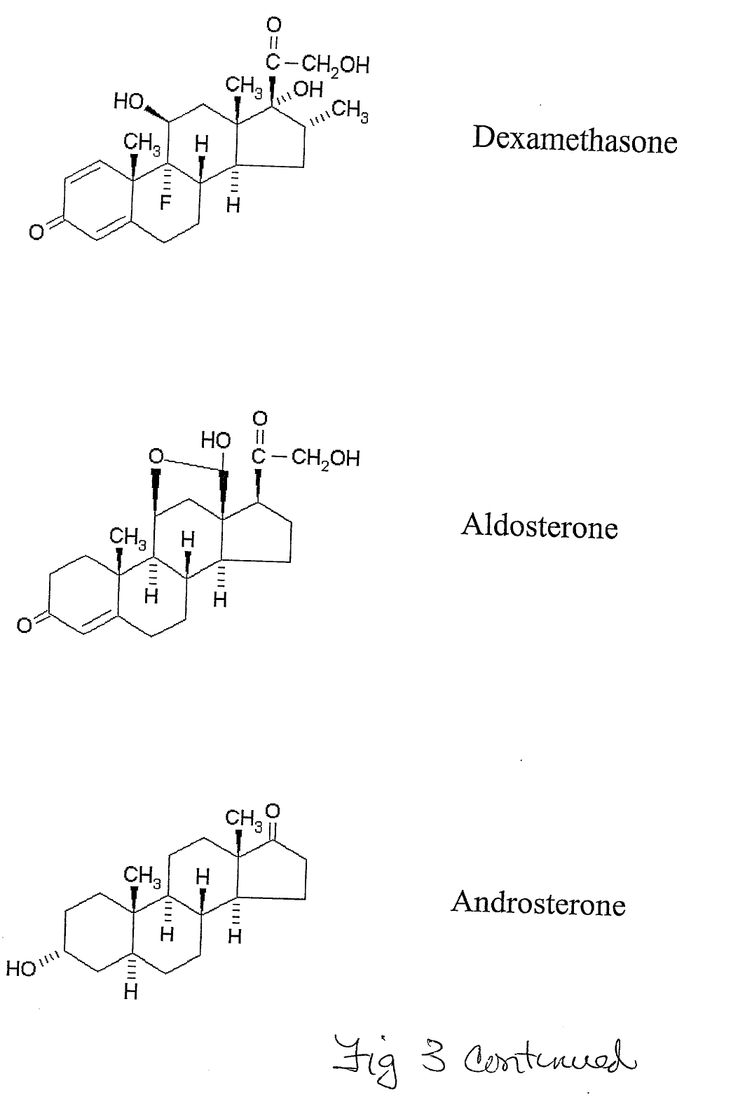

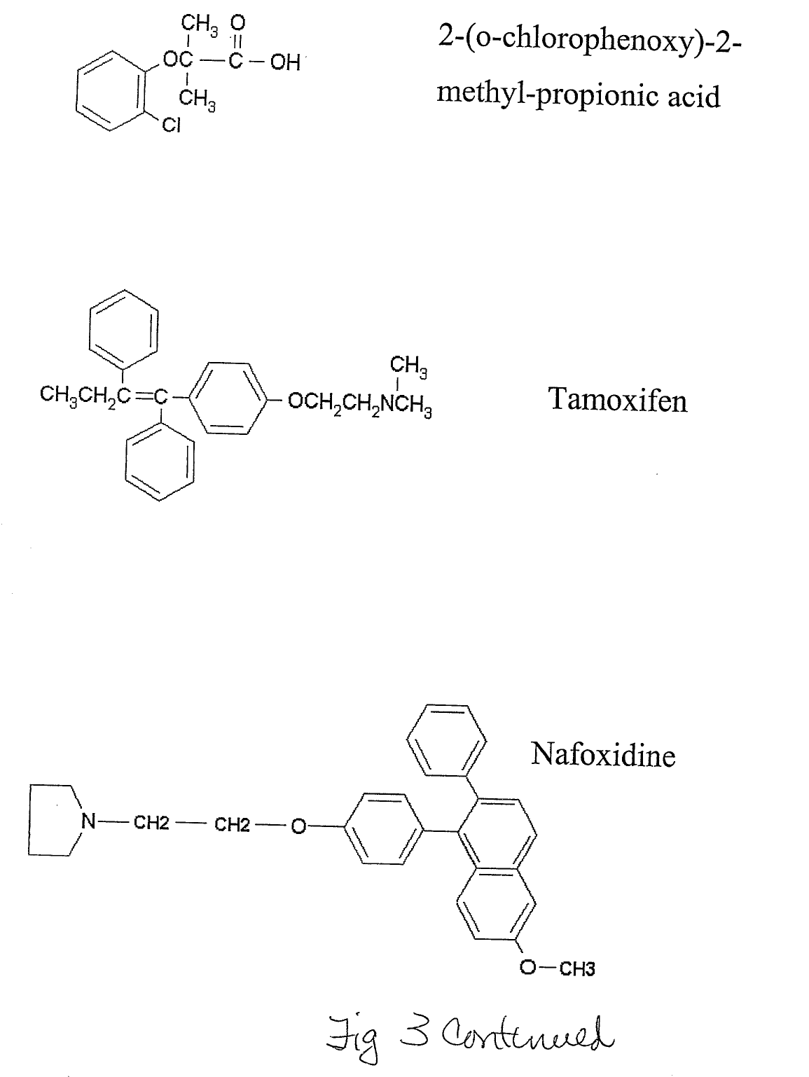

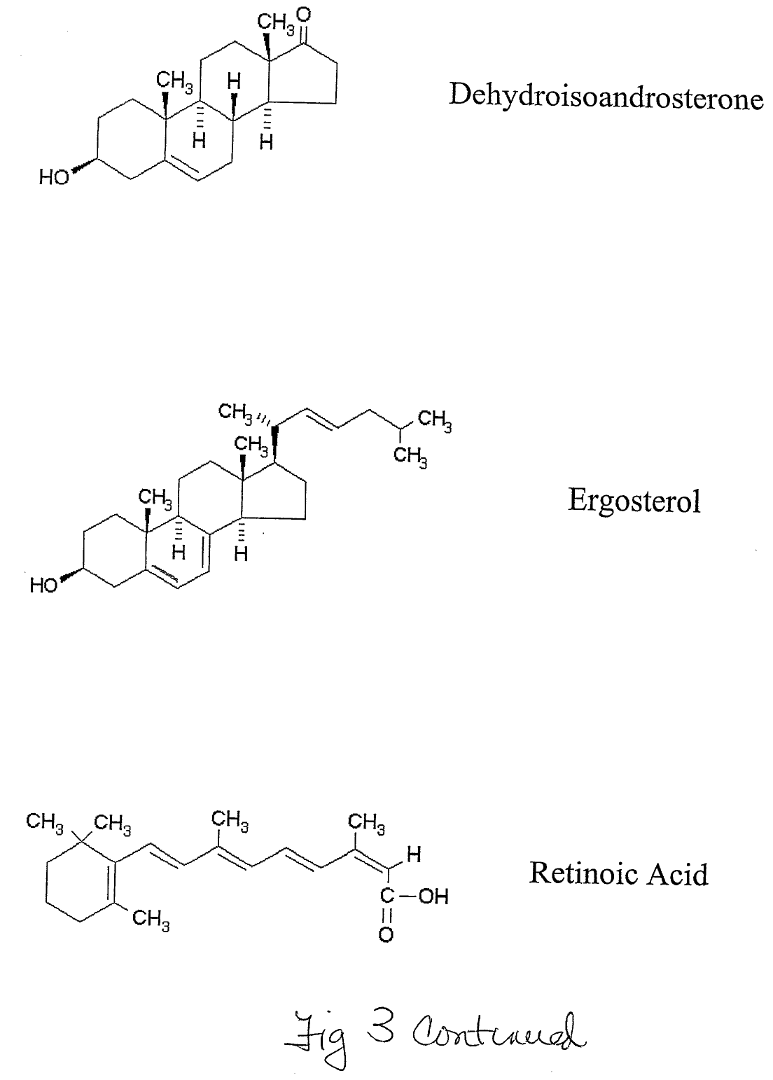

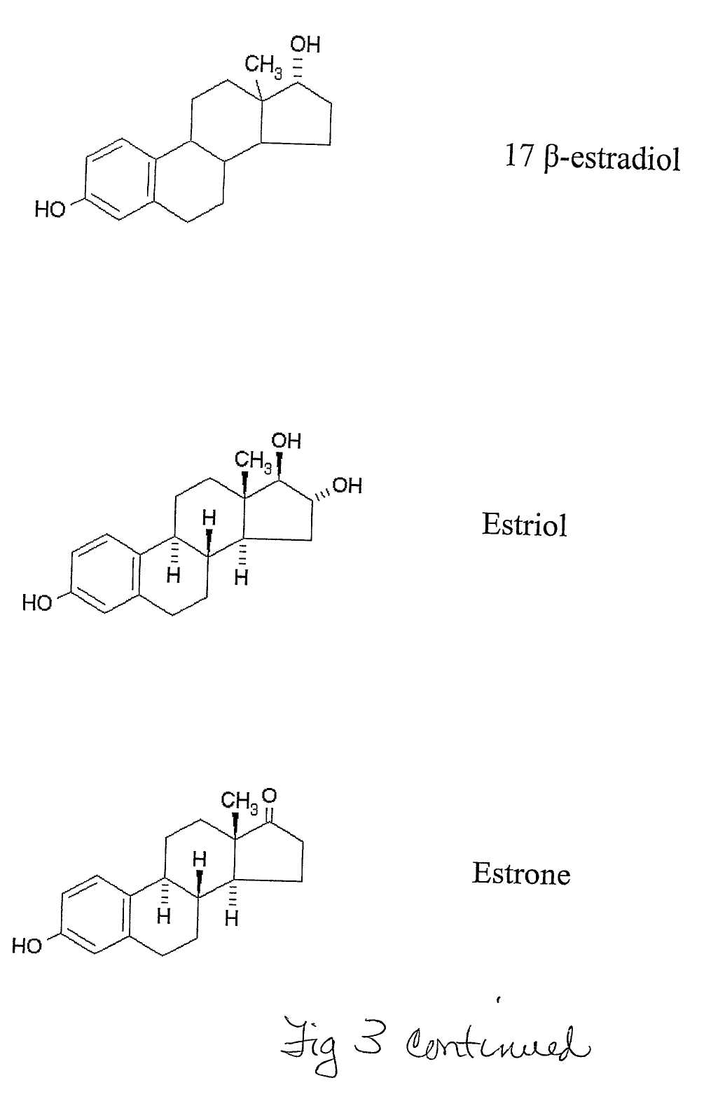

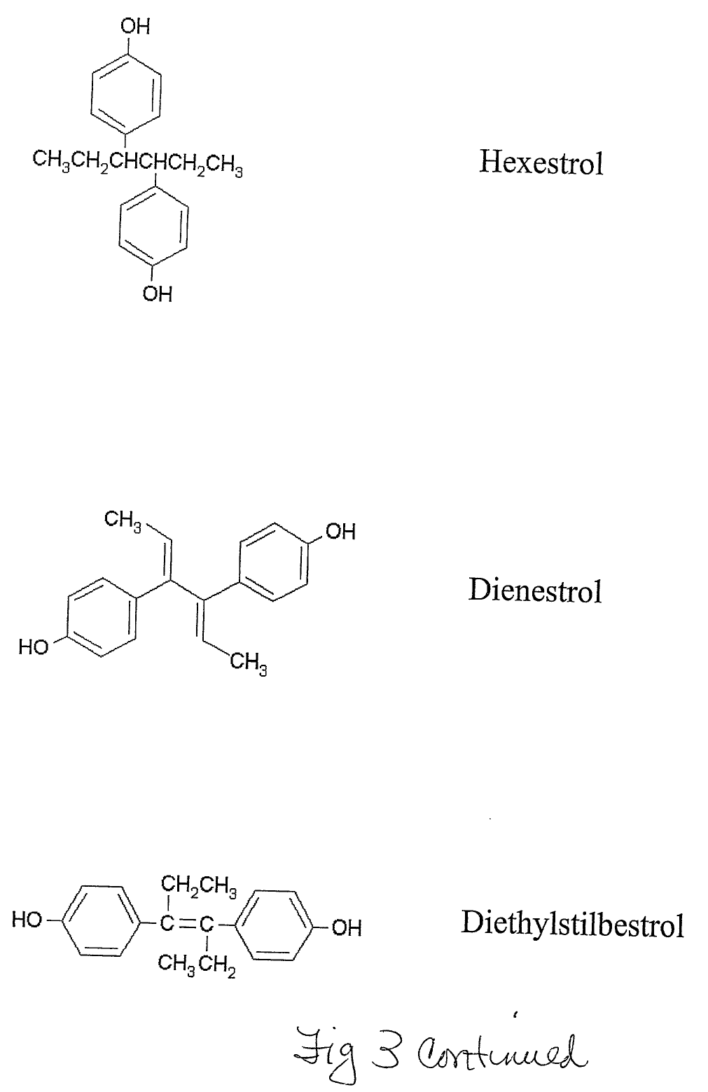

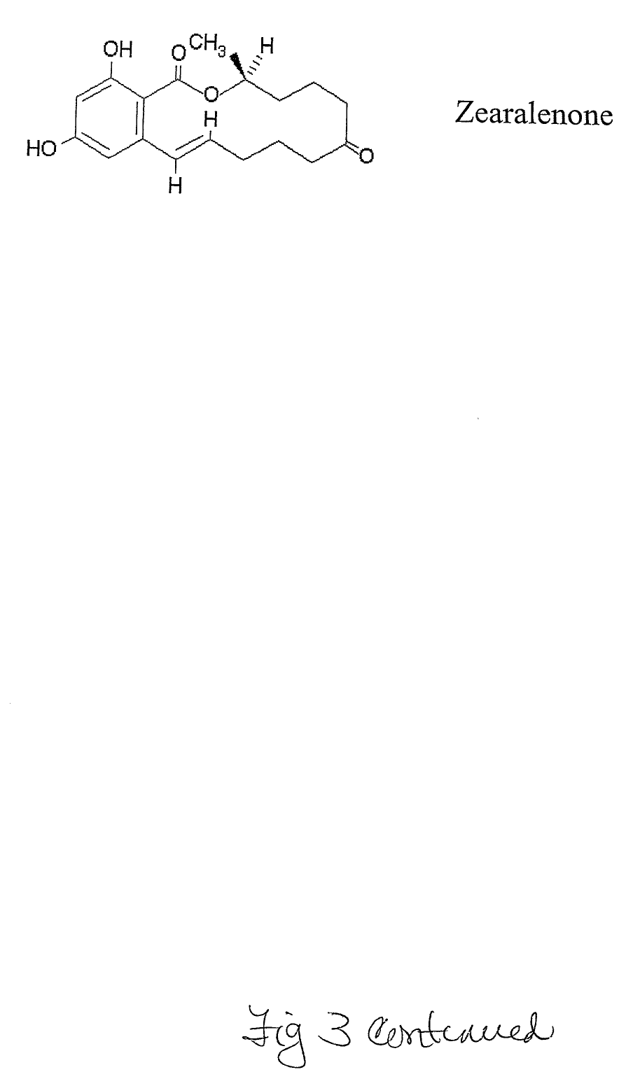

As shown in FIG. 1, the controlled and timely release of genistein leads to the activation of an extracellular peroxidase-like NADH oxidase (Nox II). Activation of Nox II is accompanied by the dismutation of superoxide by genistein to form hydrogen peroxide. It is proposed that this generation of hypersensitive cell death is the equivalent in plants to apoptosis or programmed cell death. If the hydrogen peroxide is scavenged, however, through the action of lignin/suberin peroxidases and the subsequent formation of extracellular phenolic polymers, the cells are rescued from the HR cell death program and instead enter a competent state for phytoalexin accumulation in response to glucan elicitors from the pathogen. Thus, genistein is proposed to be a primary signal in the initiation of at least two defense programs, HR cell death and phytoalexin elicitation competency.

FIG. 2 shows the structure of several peroxisome proliferators useful in the present methods.

FIG. 3 shows the structures of additional nuclear receptor ligands useful in the present methods.

### DETAILED DESCRIPTION OF THE INVENTION

The present invention provides new methods for combating plant pathogens. More specifically, the present invention provides methods of inducing the production of isoflavones in a plant. The methods comprise applying an effective amount of a formulation comprising a loader to the surface of at least part of a plant capable of producing an isoflavone, thereby inducing the production of isoflavones. As used herein, the term “plant” encompasses all forms and organs of a moncotyledenous or dicoteyledonous plant, including but not limited to the seed, the seedling, and mature plant. Plants capable of producing isoflavones include those plants that naturally produce isoflavones, such as plants in the family Leguminosae, subfamily Papilionoidease, as well as plants that have been genetically engineered to produce isoflavones. Optionally, the formulation also comprises a phytologically acceptable carrier. In accordance with the present method, it was determined that plants treated with a biologically active formulation had a higher level of isoflavones than found in non-treated plants. This increase was found in all plant parts tested, including seeds, cotyledons, leaves, and stems.

The loader is a nuclear receptor ligand (NRL) selected from the group consisting of

(1) a steroid having structure I or structure II as below,

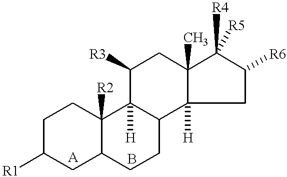

Wherein rings A, B have the same or different degrees of saturation,

wherein

R1=OH or O,

R2=H or CH₃,

R3=O, OH, or H,

R4=O, OH, H or CO₂H, C(O)CH₂OH or C(O)CH₃

R5=OH or H, and

R6=CH₃, OH or H;

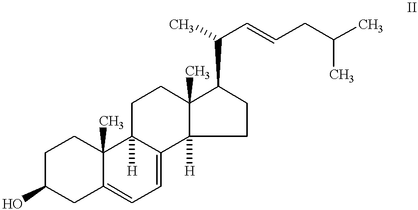

(2) a phenolic compound, wherein the phenolic compound is a phenolic estrogen or a diphenyl having structure III as below,

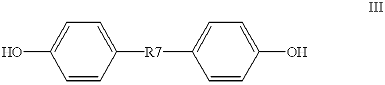

Wherein R7=a direct connection (single bond) or a branched or unbranched alkene or alkane;

(3) a long chain fatty acid having structure IV below,

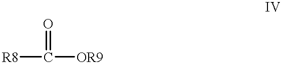

Wherein R8 is a saturated or unsaturated aliphatic chain comprising from 5 to 25 carbon atoms and R9 is a hydrogen or an aliphatic chain with 1-5 carbons;

(4) a peroxisome proliferator having structure V below,

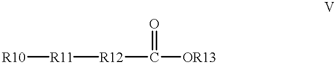

Wherein R10 is an aromatic ring or rings,

R11 is an O or S,

R12 is a branched or linear aliphatic chain comprising 1-8 carbons,

R13 is an aliphatic chain comprising from 1 to 5 carbon atoms; and

(5) the fungal steroid zearalenone, having structure VI below,

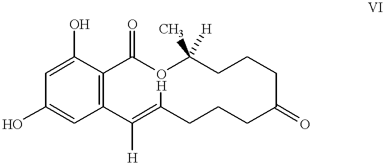

Non-limiting examples of steroids useful in the present composition and method are natural estrogens such as 17-beta-estradiol, estrone and estriol; flingal steroids such as ergosterol, and zearalenone; androgens such as aldosterone and androsterone; progestins such as progesterone and pregnenolone; and glucocorticoids such as dexamethasone, cortisone and hydro cortisone, all of which are commercially available.

Non-limiting examples of phenolic estrogens suitable for use in the present method are naturally occurring phytoestrogens such as for example, genistein, daidzein, and coumesterol.

Included with the diphenyl compounds having the structure III are estrogen agonists, i.e., synthetic compounds which bind to either the alpha or the beta estrogen receptor. Examples of estrogen agonists that are suitable for use in the present method are diethylstilbestrol, dienestrol and hexestrol.

Peroxisome proliferators are compounds that induce hepatomegaly, a marked proliferation of peroxisomes in liver parenchymal cells and an increase in peroxisomal betaoxidation of fatty acids in rat cells. While there are many assays for these effects, a simple assay for detection of peroxisome proliferators uses a reporter gene construct derived from an enzyme in the peroxisomal beta-oxidation pathway (M. J. Lee, P. Gee, S. E. Beard. 1997. Detection of peroxisome proliferators using a reporter construct derived from the rat acylj-CoA oxidase promoter in the rat liver cell line H-4-II-E., Cancer Research 57:1575-1579.) Peroxisome proliferators that are especially well-suited for use in the present method are clofibric acid, ciprofibrate, and 2-(o-chlorophenoxy)-2-methylpropionic acid (CPMPA), all of which are commercially available.

Examples of the long chain fatty acids which are suitable in the present method are arachidonic acid, linoleic acid, docosahexanoic acid, eicosapentaenoic acid, pretroselenic acid, oleic acid and elaidic acid.

Carrier

While the biologically active formulation of the present invention may be comprised of a nuclear receptor ligand alone, it is preferred that the formulation also includes one or more phytologically acceptable diluents or adjuvants. The term “phytologically acceptable” means a non-toxic material that does not interfere with the effectiveness of the NRL. The usefulness of a particular adjuvant or carrier depends on, among other factors, the species of the plant being treated with the formulation of the invention, the plant's growth stage and the related environmental conditions, the route of administration and the particular compound or combination of compounds in the composition. Useful adjuvants include, without limitation, crop oil concentrates, surfactants, fertilizers, emulsifiers, dispersing agents, foaming activators, foam suppressants, and correctives. Adjuvants generally facilitate the entry of the nuclear receptor active ingredient through plant cell walls. In a more preferred embodiment, the one or more adjuvants in the biologically active formulation are a crop oil concentrate, a surfactant and a fertilizer.

In a further embodiment of the invention, the biologically active formulation may also contain one or more other active chemicals, such as herbicides, insecticides, fungicides, bacteriocides, ,and plant growth regulators. As used in the present invention, the term “other active chemicals” refers to those chemicals having activities other than the ability to induce the production of isoflavones in plants, such as insecticidal, herbicidal, flungicidal, bacteriocidal, etc. In a preferred embodiment, the one or more other active chemicals in the biologically active formulation is a herbicide. Non-limiting examples of, acceptable herbicides include 2,4-DB, Assure®/Assure II, Basagran®, Classic®, Firstrate®, Fusiladeg® DX, Option®, Passport®, Pinnacle®, Pursuit®, Pursuit Plus®, Reliance T®, STS®, Roundup Ultra®, Select® 2 EC, Scepter®, and SynchronyTm STS®. Selective.

The composition may further contain other agents which either enhance the activity of the NRL or complement its activity. Examples of such compounds are “tappers”, which can either enhance the release of the isoflavones from their conjugates upon infection or enhance the incorporation of these compounds into glyceollin. Examples of tappers are ion effectors, such as orthovanadate, and compounds capable of generation of reactive oxygen intermediates, such as rose bengal and selective tetrazolium redox dyes. Another example of a enhancing compound for incorporation in the composition would be elicitors of the phytoalexin glyceollin, including but not limited to salts of copper and fragments of the naturally occuring cell wall glucan from the pathogen Phytophthora sojae. Such additional factors or agents may be included in the composition to produce a synergistic effect with the NRL, or to minimize side effects. The composition may further comprise fillers, salts; buffers, stabilizers, solubilizers, and other materials well known in the art.

The biologically active composition is prepared by mixing one or a mixture of the above described NRL's with the carrier and other ingredients. For field use, various volumes of the formulation may be prepared. Preparation of such formulations is within the level of skill in the art.

Dosage

A biologically effective amount is an amount sufficient to increase the levels of an isoflavone, such as for example genistein or daidzein, in the treated plant above levels found in control untreated plants. Such amounts can be determined by routine testing such as measurement by high performance liquid chromatography as noted below. The effective amount can be achieved by one application of the formulation. Alternatively, the effective amount is achieved by multiple applications of the formulation to. the plant. The amount of the NRL in the composition will depend upon the particular compound or mixture of compounds being employed, the plant tissue being treated, and the ability of the plant to take up the composition. For instance, young plant leaves take up most compositions more readily than older leaves. It is contemplated that the various compositions used to practice the method of the present invention should contain from about 20 micromolar to 2 millimolar per dose of the NRL.

Application of the Composition to the Plant

The composition would typically be applied to seeds, roots, leaves, stems, or combinations thereof. Typically, the composition may be administered to seed by coating the seed with a powdered composition, which may include a “sticker”, to the soil, seed and/or root zone either as a liquid or in a granulated form in the soil, or as a spray to the leaves and stems. The composition may be applied to the surface of the plant in a single application until the leaves of the plant are partially wetted, fully wetted or until runoff. The treatment of the plant may also involve adding the composition to the water supply of the plants, or in the case of plants grown by tissue culture, to the culture media.

The formulation may be applied at any time of day or night with good resistance resulting, but preferentially on actively growing plants and at least 30 minutes before a predicted rainfall. The application can be repeated as often as considered useful, with one or more “booster” applications applied to bolster resistance should the previously induced resistance begin to fade, as evidenced by the onset of disease symptoms. Thus, the formulation may be considered “prophylactic” as well as “therapeutic.” In a preferred embodiment, the formulation is applied by spraying the formulation onto the plants. Non-limiting examples of means for spraying the formulation onto plants include a tractor boom sprayer, a hand held aerosol sprayer, airblast sprayer, and helicopter or fixed-wing aircraft boom sprayer.

Depending on the application method and conditions of application, it is expected, that the present method will provide specific and/or broad-spectrum disease control including prevention of fungal infections and also infection by bacterial, viral and nematode pathogens. Non-limiting examples of plant pathogens include insects (e.g., diptera, hymenoptera, coleoptera, lepidoptera, orthoptera, hemiptera, and homoptera), bacteria (in soybeans, for example, Pseudomonas syringae pv. glycinea and Xanthomonas campestris pv. phaseoli), viruses (in soybeans, for example, Bean Pod Mottle Virus, Cowpea Chlorotic Mottle Virus, Peanut Mottle Virus, Soybean Dwarf Virus, Soybean Mosaic Virus, Tobacco Ringspot Virus, Tobacco Streak Virus, Bean Yellow Mosaic Virus,' Black Gram Mottle Virus, Cowpea Mild Mottle Virus, Cowpea Severe Mosaic Virus, Indonesian Soybean Dwarf Virus, Mung Bean Yellow Mosaic Virus, Peanut Stripe Virus, Soybean Chlorotic Mottle Virus, Soybean Crinkle Leaf Virus, Soybean Yellow Vein Virus, and Tobacco Mosaic Virus), fungi (in soybeans, for example, Cercospora sojina, Chaetomium cupreum, Colletotrichum truncatum, Diaporthe-Phomopsis Complex, Fusarium .spp., Macrophomina phaseozina, Peronospora manschurica), and nematodes (in soybeans, for example, Soybean Cyst Nematode, Lance Nematodes, Lesion Nematodes, Reniform Nematode, Root-Knot Nematodes, and Sting Nematodes).

Non-limiting examples of plant diseases include 1) infectious diseases such as a) bacterial diseases (in soybeans, for example, Bacterial Blight, Bacterial Pustule, Bacterial Tan Spot, Wildfire, Bacterial Wilts, and Crown Gall), b) mycoplasmalike diseases (in soybeans, for example, Machismo, Bud Proliferation, Witches'-Broom and Phyllody), c) fungal diseases of foliage, upper stems, pods, and seeds (in soybeans, for example, Alternaria Leaf Spot and Pod Necrosis, Anthracnose, Brown Spot, Cercospora Blight and Leaf Spot, Choanephora Leaf Blight, Downy Mildew, Frogeye Leaf Spot, Phyllosticta Leaf Spot, Powdery Mildew, Red Leaf Blotch, Rhizoctonia Aerial Blight, Rust, Scab, and Target Spot), d) fungal diseases of roots and lower stems (in soybeans, for example, Brown Stem Rot, Charcoal Rot, Fusarium Blight or Wilt, Root Rot, and Pod and Collar Rot, Phytophthora Rot, Pod and Stem Blight and Phomopsis Seed Decay, Stem Canker, Pythium Rot, Red Crown Rot, Rhizoctonia Diseases, Sclerotinia Stem Rot, Sclerotium Blight, and Thielaviopsis Root Rot), e) viral disease (in soybeans, for example, bud blight, soybean mosaic, 0 nematode diseases, g) seedbome bacteria and bacterial diseases of seeds (in soybeans, for example, Bacillus Seed Decay), h) seedbome fungi and fungal diseases of seeds (in soybeans, for example, Alternaria Pod and Seed Decay, Purple Seed Stain, Yeast Spot (Nematospora Spot), and Phomopsis Seed Decay), i) seedbome viruses; 2) diseases of unknown or uncertain cause (in soybeans, for example, Foliage Blight, Sudden Death Syndrome, and Yellow Leaf Spot); and 3) noninfectious or stress diseases (e.g., crusting and compaction, frost, hail, heat canker, lightning, sunburn, water stress, mineral deficiencies and toxicities, herbicide damage, insecticide damage, and air pollutants). In a preferred embodiment the formulation is applied to soybean for control of phytophthora root rot, sclerotinia white mold, brown stem rot or the soybean cyst nematode.

The composition may also be administered to seeds of the plant to increase isoflavones in sprouts of the seed, thereby providing a highly beneficial food for human consumption.

The present method is particularly suited for treatment of legumes, including but not limited to soybeans, alfalfa, green beans, peas, lima beans, chickpeas, peanuts and mung beans.

Methods of Assessing the Effect of NRLS on Production of Isoflavones and the Activation of Defense Elicitors in the Soybean System.

The soybean cotyledon assay is the standard assay for assessing the activity of defense elicitors in the soybean system. There are two adaptations of this assay which can be used to determine the effective concentration of the nuclear receptor ligands.

Cut cotyledon assay

The cut cotyledon assay is used to investigate both the ability of the nuclear receptor ligand to activate basal elicitation competency in plants, and to evaluate the ability of a second compound such as the glucan defense elicitor from the fungal pathogen Phytophthora sojae to enhance glyceollin elicitation competency in plants in which the isoflavone pools were “loaded” by the action of the ligand. The level of isoflavones in the cotyledon tissues are measured after the addition of different nuclear receptor ligands to determine the effectiveness of each in inducing the basal production of isoflavones in cotyledon tissues. In such studies, the addition of the nuclear receptor ligand first “primes” the cut cotyledon, i.e., increases the levels of the isoflavone daidzen. That is, the competency for the elicitation of the phytoalexin glyceollin in response to the glucan elicitor from Phytophthora sojae is already partially activated. This means that increases in the isoflavone daidzein, which is the precursor for glyceollin, are usually rapidly shunted into glyceollin when the glucan defense elicitor is added to the system. Thus, the ability of the ligand to enhance glyceollin elicitation competency by “loading” the isoflavone pools can also be measured.

Cotyledons from 7-8 day old soybean seedlings are removed from the plant and cut on the lower surface to expose subepidermal tissues. A 30 p,L drop of test compound (elicitor and/or loader) is placed on the cut surface. Ten cotyledons are used per treatment and arranged in a petri plate containing a wet filter paper to keep the cotyledons moist. After incubation at room temperature at approximately 200 p.Einsteins of light for 48 hr the cotyledon tissues are harvested for analysis. Tissues for analysis are harvested by cutting a vertical column of cells from the cotyledon using a number 1 cork borer. The column of cells is then subsampled by cutting slices of cells progressively away from the original cut surface. The first section is approximately 4 cell layers thick and the second two are approximately 8 cell layers thick. These allow the examination of proximal and distal effects of treatments, respectively. Tissues are analyzed by HPLC as noted below. Full details of this assay can be found in the publication: Graham, T. L., and Graham, M. Y. 1991. Glyceollin Elicitors Induce Major But Distinctly Different Shifts in Isoflavonoid Metabolism in Local and Distal Cell Populations. Molecular Plant Microbe Interactions 4:60-68, which is specifically incorporated herein by reference.

Snapped cotyledon assay

The snapped cotyledon assay is a minimal wound assay used to investigate the effects of test compounds in a non-primed background. The assay is performed by snapping cotyledons in two and placing the petiole side down in 0.5% water agar. Ten snapped cotyledons are used per treatment, and the subepidermal cells exposed by snapping are treated with glucan defense elicitor and/or the effector being examined. The cotyledons are incubated in the light for 48 hr as in the cut cotyledon assay. Both proximal (first cell layer) and distal (second and third cell layers) are harvested for analysis by HPLC (see below). Full details of this assay can be found in the publication: Graham, T. L. and Graham, M. Y. 1996. Signaling in soybean phenylpropanoid responses: dissection of primary, secondary and conditioning-effects of light, wounding and elicitor treatments. Plant Physiol. 110:1123-1133, which is specifically incorporated herein by reference.

The snapped cotyledon assay is “naive”. That is, it is not pre-disposed or primed for competency for the elicitation of phytoalexin glyceollin in response to the glucan elicitor. Thus, treatment with the glucan elicitor induces the formation of the isoflavones daidzein and genistein, but very little glyceollin. This is an excellent assay to study the effects of a chemical treatment on isoflavone metabolism by itself or in combination with the glucan. In the absence of the glucan, it gives an excellent picture of the effects of the compound alone on isoflavone metabolism. In the presence of the glucan, it tells us if the test compound can induce elicitation competency for the glyceollin response to the glucan.

HPLC analysis for isoflavone and glyceollin defense responses of cotyledons.

High performance liquid chromatography (HPLC) is the . method of choice for determining the levels of isoflavone defense compounds in soybean. With a single HPLC analysis, one gets a complete and quantitative profile of up to 50 or more aromatic compounds, including all the isoflavones and their conjugates and the phytoalexins, including glyceollin. As little as 20 mg of plant tissue is needed and the method can be readily applied to cotyledon, leaf or any soybean tissue. This analytical method allows us to determine the nmoles/gm of each metabolite, which can then readily be processed to compare the percent increase or decrease of a given metabolite in comparison to either water or glucan treated control tissues. Routinely, tissues are extracted in 80% ethanol and subjected to water/acetonitrile gradient elution from a C18 reverse phase HPLC column. Full details of this procedure can be found in the publication: Graham, T. L. 1991. A Rapid, High Resolution High Performance Liquid Chromatography Profiling Procedure for Plant and Microbial Aromatic Secondary Metabolites. Plant Physiology 95:584-593, which is specifically incorporated herein by reference.

Analysis for protection against fungal pathogens

In the laboratory, actual protection of tissues against fungal pathogens is measured by applying a test chemical or mixture of test chemicals to a small wound at one end of a soybean cotyledon. Various times after this treatment, the fungus is inoculated either at the point of chemical application or at the other end of the cotyledon. Disease progression is then measured using disease ratings over time and the effects of the treatment on protection is evaluated by examining the disease progress curve (simply the disease rating with time). In most tests, the fungal pathogen Phytophthora sojae is used. The evaluation of protection in the field is measured by rating the naturally infection process with time in treated and control plots.

### EXAMPLES

Exemplary methods and compositions are described below, although methods and materials similar or equivalent to those described herein can be used in the practice or testing of the present compositions and methods. All publications and other references mentioned herein are incorporated by reference in their entirety. The materials, methods, and examples are illustrative only and not intended to be limiting.

### Example 1

### Induction of Isoflavone Levels in Cotyledons Treated with a Nuclear Receptor Ligand.

Cotyledons (10 per treatment) from 7 day old Williams variety soybean were treated with a formulation comprising estrogens, estrogen agonists, and peroxisome proliferators. Each NRL was dissolved either in water or first in isopropanol to give a saturated solution followed by rapid dilution in water. Final concentration of isopropanol did not exceed 0.5%. NRLs were tested over a concentration range of about 10 uM to 1 mM, using serial 3 fold dilutions from 1 mM. NRLs were tested both alone and in the presence of 30 ug/ml of the glucan elicitor from the fungal pathogen Phytophthora sojae. Concentrations of the NRL and glucan noted here are final concentrations on the treated cotyledon.

The exposed surface of each snapped cotyledon was treated with 7 μL of the NRL followed by 7 μL of the glucan or water. Cotyledons were incubated in constant light (200 t;,Einsetins) for 48 hr. At 48 hr, a thin (translucent) section was harvested from the treated cotyledon surface. Sections from the 10 cotyledons for each treatment were pooled and extracted in 80% ethanol (400 μL for each 50 mG fresh weight). The extract was then subjected to HPLC as described above. The results, as shown in Tables 1-4 below, indicate that the ligands were capable of both increasing levels of isoflavones, and “priming” glyceollin competency of the treated plants.

TABLE 1
Potentiation of Soybean Phytoalexin Elicitation by
Nuclear Receptor Ligands

| Pre-Treatement | Percent Increase | Pre-treatment | Percent Increase |
|---|---|---|---|
| None | 0% | Diethylstilbestrol | 86% |
| Genistein* | 231% | Coumestrol | 226% |
| Beta-Estradiol | 205% | Zearalenone | 242% |
| Estriol | 177% | Ergosterol | 260% |
| Dienestrol | 75% | Ciprofibrate | 199% |
| ¹Values represent the percent increase in glyceollin elicitation compared to a glucan elicitor control in the soybean cut cotyledon assay (cultivar Williams). Compounds were tested at 33 uM and applied immediately before the glucan elicitor and 10 uM orthovanadate, a competency co-activator (“tapper”). Each individual assay included ten cotyledons (subsamples) which were pooled for HPLC analysis. Values are the average of two separate experiments. The standard | | | |
| # error was less than 18% of the average for all values. For comparative purposes, the values in Table 1 represent near saturation effects of those compounds. For instance, beta-estradiol is active at concentrations as low as 100 nM. | | | |

*Genistein is inherently unstable to oxidation and this value represents the application of smaller doses of genistein on an hourly basis for 8 hours.

TABLE 2
Loading of Daidzein Conjugate Pools by Nuclear Receptor Ligands¹

| Treatment | Percent Increase | Treatment | Percent Increase |
|---|---|---|---|
| None | 0% | Diethylstilbestrol | 36% |
| | | Coumestrol | 54% |
| Beta-Estradiol | 64% | Zearalenone | 58% |
| Estriol | 45% | Ergosterol | 60% |
| Dienestrol | 28% | Ciprofibrate | 52% |

¹Values represent the percent increase in total daidzein conjugate pools compared to a water control in the soybean cut cotyledon assay (cultivar Williams). Compounds were tested at 33 uM. Each individual assay included ten cotyledons (subsamples) which were pooled for HPLC analysis. Values are the average of two separate experiments. The standard error was less than 12% of the average for all values.

TABLE 3
Loading of Isoflavone Conjugate Pools by Nuclear Receptor Ligands¹

| Treatment | Percent Increase | Treatment Percent | Increase |
|---|---|---|---|
| Estradiol | +64% | Ergosterol | +60% |
| Estroil | +45% | Ciprofibrate | +52% |
| Dienestrol | +28% | CPMPA | +42% |
| Genistein* | +54% | | |

¹Values represent the percent increase in daidzein conjugate pools compared to a water control in the soybean snapped cotyledon assay (cultivar Williams). Compounds were tested at 33 uM. Each individual assay included ten cotyledons (subsamples) which were pooled for HPLC analysis. Values are the average of two separate experiments. The standard error was less than 12% of the average for all values.
*Genistein is inherently unstable to oxidation and this value represents the application of smaller doses of genistein on an hourly basis for 8 hours.

TABLE 4
Loading of Daidzein Conjugate Pools by Nuclear Receptor Ligands

| Treatment | Percent Increase | Treatment | Percent Increase |
|---|---|---|---|
| None | 0% | Diethylstilbestrol | 38% |
| | | Coumestrol | 54% |
| B-iEstradiol | 64% | Zearalenone | 58% |
| lEstriol | 45% | Ergosterol | 60% |
| Dienestrol | 28% | Ciprofibrate | 52% |

¹Values represent the percent increase in total daidzein conjugate pools compared to a water control in the soybean cut cotyledon assay (cultivar Williams). Compounds were tested at 33 uM. Each individual assay included ten cotyledons (subsamples) which were pooled for HPLC analysis. Values are the average of two separate experiments. The standard error was less than 12% of the average for all values.

### Example 2

### Treatment with Other NRLs

Additional NRLs, particularly additional steroids, were tested in the cut cotyledon assay (Williams cotyledons) over a range of concentrations from 50-500 p,M. The following are the activities of these NRLs, expressed as the range of increase of isoflavones seen over this concentration range:

| | |
|---|---|
| Progesterone | 20-60% |
| androsterone | 30-40% |
| hydrocortisone | 25-50% |
| cortisone | 30-100% |
| dexamethasone | 0-10% |
| 5-pregnenolone | 5-20% |

### Example 3

### Treatment of Plants Other Than Soybeans

Legumes including lima bean, mung bean, green bean, peanuts, and chickpeas are treated with compositions comprising the NRL in the cut cotyledon assay as described above in Example 1. The compositions are applied to cotyledons of plants of appropriate age for the assay, that is, tissues which were fully expanded, green and non-senescent. Application of the fungal steroid ergosterol at 100 p,M to the above named legumes resulted in increases in isoflavones ranging from 2-60 fold in each plant species. The actual isoflavones induced are known or unknown depending on the plant species, but were identified as isoflavones by their ultraviolet spectra.

### Example 4

### Treatment of Other Plant Organs

True leaves of soybean plants are also treated as described above in Example 1. For tests on true leaves of soybean or other plants, two methods are used. In the laboratory a small spot on the leaves is vacuum filtrated using a filter disc platform hooked to a water aspirator. The leaf is placed on the filter disc platform and mild suction applied. A drop of the glucan elicitor and the nuclear receptor ligand formulation is then placed on the exposed surface of the leaf and allowed to infiltrate the tissue through the leaf stomatal pores. For the greenhouse or field, the nuclear receptor ligand is added to a surfactant to emulsify and disperse the ligand. In all of these assays, the tissues are again analyzed by HPLC as described above.

### Example 5

### Soybean Leaf Isoflavone Increases after Ergosterol Treatment

Soybean leaves do not normally contain appreciable levels of isoflavones. Moreover, the isoflavone formononetin is normally found only as a trace metabolite in soybean tissues. It is commonly found in chickpea. Treatment of soybean leaves with a nuclear receptor ligand, however, caused very significant accumulations of daidzein and formononetin aglycones and genistein conjugates. The table below shows the responses of leaf tissue to various concentrations of ergosterol as a percent increase over the appropriate control treatment. Ergosterol was directly infiltrated into the primary leaves, which were analyzed after 48 hours. The data demonstrate that very low concentrations of the nuclear receptor ligands not only induce isoflavones in soybean leaves, but redirect the normal isoflavone metabolic pathways to reoduce new compounds. terol Increase in

| Ergosterol | Increase in | Increase | Increase in |
|---|---|---|---|
| Concentration | Genistein | in Daidzein | Formononetin |
| (micromolar) | Conjugates | Aglycone | Aglycone |
| 1 | 2X | 5X | 24X |
| 10 | 1.1X | 3X | 27X |
| 100 | None | 2.4X | 4X |

What is claimed is:

1. A method of inducing production of isoflavones in a plant comprising:
a) applying a biologically effective amount of composition comprising a nuclear receptor ligand selected from the group consisting of:
a steroid having structure I or structure II as below, 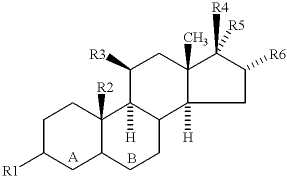
Wherein rings A, B have the same or different degrees of saturation,
wherein
R1=OH or O,
R2=H or CH₃,
R3=O, OH, or H,
R4=O, OH, H, CO₂H, C(O)CH₂OH, or C(O)CH₃,
R5=OH or H, and
R6=CH₃, OH or H; 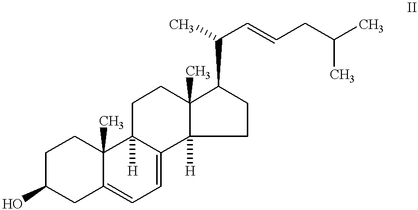
(2) a phenolic compound, wherein the phendlic compound is a phenolic estrogen or a diphenyl having structure III as below, 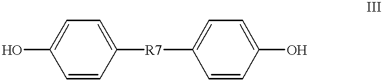
Wherein R7=a direct connection (single bond) or a branched or unbranched alkene or alkane;
(3) a long chain fatty acid having structure IV below, 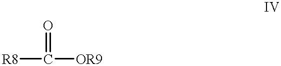
Wherein R8 is a saturated or unsaturated aliphatic chain comprising from 5 to 25 carbon atoms and R9 is a hydrogen or an aliphatic chain with 1-5 carbons;
(4) a peroxisome proliferator having structure V below, 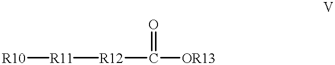
Wherein R10 is an aromatic ring or rings,
R11 is an O or S,
R12 is a branched or linear aliphatic chain comprising 1-8 carbons,
R13 is an aliphatic chain comprising from 1 to 5 carbon atoms; and
(5) the fungal steroid zearalenone, having structure VI below,

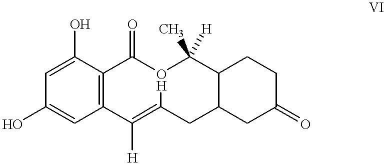

2. The method of claim 1 wherein the nuclear receptor ligand is a steroid.

3. The method of claim 2 wherein the steroid is selected from the group consisting of 17-beta-estradiol, estrone, estriol, ergosterol, zearalenorie, aldosterone, androsterone, progesterone, pregnenolone, dexamethasone, cortisone, hydrocortisone, and combinations thereof.

4. The method of claim 1 wherein the nuclear receptor ligand is a phenolic compound.

5. The method of claim 4 wherein the phenolic compound is selected from the group consisting of genistein, daidzein, and coumesterol.

6. The method of claim 4 wherein the phenolic compound is an estrogen agonist.

7. The method of claim 6 wherein the estrogen agonist is diethylstilbestrol, dienestrol or hexestrol.

8. The method of claim 1 wherein the nuclear receptor ligand is a long chain fatty acid.

9. The method of claim 8 wherein the long chain fatty acid is selected from the group consisting of arachidonic acid, linoleic acid, docosahexanoic acid, eicosapentaenoic acid, pretroselenic acid, oleic acid and elaidic acid.

10. The method of claim 1 wherein the nuclear receptor ligand is a peroxisome proliferator.

11. The method of claim 10 wherein the peroxisome proliferator is selected from the group consisting of clofibric acid, ciprofibrate, and 2-(o-chlorophenoxy)-2-methylpropionic acid (CPMPA).

12. The method of claim 1 wherein the composition further comprises a compound which enhances the activity of the nuclear receptor ligand.

13. The method of claim 12 wherein the enhancing compound is orthovanadate, rose bengal, or a tetrazolium redox dye.

14. The method of claim 12 wherein the enhancing compound is a copper salt or a fragment of the naturally occuring cell wall glucan from the pathogen Phytophthora sojae.

15. The method of claim 1 wherein the composition further comprises one or more compounds selected from the group consisting of a phytologically acceptable diluent or adjuvant.

16. The method of claim 1 wherein the composition further comprises one or more active chemicals selected from the group consisting of a herbicide, an insecticide, a fungicide, and a bacteriocide.

17. The method of claim 1 wherein the composition is applied to the plant stem, the plant root, the plant leaf, or combinations thereof.

18. The method of claim 1 wherein the composition is applied to a seed or a seedling.

19. The method of claim 1 wherein the composition is applied to a legume selected from the group consisting of alfalfa, lima bean, pinto bean, chickpea, peanuts, and soybean.

20. The method of claim 19 wherein the legume is soybean.

21. A composition for enhancing levels of isoflavones in a plant or seed, comprising: one or more nuclear receptor ligands and one or more compounds which enhance the activity of the nuclear receptor ligand; wherein said nuclear receptor ligands are selected from the group consisting of
(1) a steroid having structure I or structure II as below, 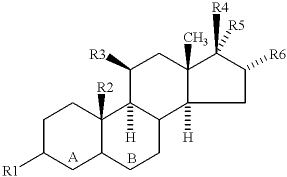
Wherein rings A, B have the same or different degrees of saturation,
wherein
R1=OH or O,
R2=H or CH₃,
R3=O, OH, or H,
R4=O, OH, H or CO₂H, C(O)CH₂OH or C(O)CH₃
R5=OH or H, and
R6=CH₃, OH or H; 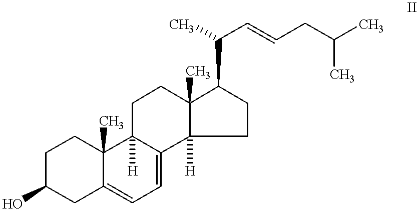
2) a phenolic compound, wherein the phenolic compound is a phenolic estrogen or a diphenyl having structure III as below, 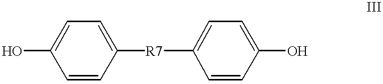
Wherein R7=a direct connection (single bond) or a branched or unbranched alkene or alkane;
(3) a long chain fatty acid having structure IV below, 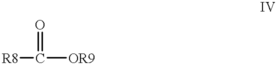
Wherein R8 is a saturated or unsaturated aliphatic chain comprising from 5 to 25 carbon atoms and R9 is a hydrogen or an aliphatic chain with 1-5 carbons;
(4) a peroxisome proliferator having structure V below, 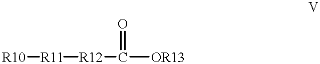
Wherein R10 is an aromatic ring or rings,
R11 is an O or S,
R12 is a branched or linear aliphatic chain comprising 1-8 carbons,
R13 is an aliphatic chain comprising from 1 to 5 carbon atoms; and
(5) the fungal steroid zearalenone, having structure VI below,

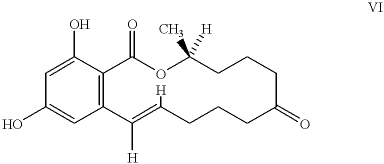

22. The method of claim 21 wherein the enhancing compound is orthovanadate, rose bengal, or a tetrazolium redox dye.

23. The method of claim 21 wherein the enhancing compound is a copper salt or a fragment of the naturally occuring cell wall glucan from the pathogen Phytophthora sojae.
